(19) United States
(12) Patent Application Publication
(10) Pub. No.: US 2013/0091833 A1
(43) Pub. Date: Apr. 18, 2013

(54) Hydraulic control system and hydraulic control method

(71) Applicants: Chunxin Zhan, Changsha (CN); Quan Liu, Changsha (CN); Yuan Zhang, Changsha (CN); Chunyang Song, Changsha (CN); Shaojun Wang, Changsha (CN); Zhihua Yuan, Changsha (CN)

(72) Inventors: Chunxin Zhan, Changsha (CN); Quan Liu, Changsha (CN); Yuan Zhang, Changsha (CN); Chunyang Song, Changsha (CN); Shaojun Wang, Changsha (CN); Zhihua Yuan, Changsha (CN)

(73) Assignees: HUNAN ZOOMLION SPECIAL VEHICLE CO., LTD, Changde, Hunan (CN); ZOOMLION HEAVY INDUSTRY SCIENCE AND TECHNOLOGY CO. LTD., Changsha, Hunan (CN)

(21) Appl. No.: 13/641,096

(22) PCT Filed: Apr. 11, 2011
(86) PCT No.: PCT/CN2011/072627

§ 371 Date: Dec. 25, 2012

(30) Foreign Application Priority Data
Apr. 13, 2010 (CN) 201010145313.8

(51) Int. Cl. F15B 15/18

(52) U.S. Cl. CPC F15B 15/18
USPC 60/327; 60/486; 60/435; 60/459; 60/445

(57) ABSTRACT

A hydraulic control system and a hydraulic control method are disclosed. The hydraulic control system comprises a first closed pump (P1) and a first engine (M1) connected with each other, a second closed pump (P2) and a second engine (M2) connected with each other, and a hydraulic motor (P3). The first closed pump (P1), the second closed pump (P2) and the hydraulic motor (P3) are connected in parallel. Compared with the prior art, the present hydraulic control system has advantages of wider engine model selection range, higher reliability and better micro-motion performance.

### TECHNICAL FIELD OF THE INVENTION

The invention relates to the field of hydraulic technology, in particular to a hydraulic control system and a hydraulic control method.

### BACKGROUND OF THE INVENTION

With the development of economy, super large tonnage cranes are applied broadly in production and construction, and a hydraulic control system of these super large tonnage cranes mainly includes an open loop system and a closed loop system. Specifically, a hydraulic control system of these super large tonnage cranes includes an open loop system with double pumps connected in parallel and a closed loop control system driven by a single pump.

Since the closed loop control system driven by a single pump is driven only by a single pump, the single pump engine should meet the requirements of large tonnage cranes, thus bringing about limitation to model selection. Although the difficulty in model selection of super large tonnage engines may be solved by the open loop system with double pumps connected in parallel, the open loop system is designed with complicated pipelines with high heat emission and multiple fault sources. Therefore, the micro-motion performance is not satisfactory enough.

Engine model selection of the hydraulic control system is largely limited in related technical solutions, or the system is designed with complicated pipelines with high heat emission, multiple fault sources, and unsatisfactory micro-motion performance. Currently, there are no solutions for solving these problems effectively.

### SUMMARY OF THE INVENTION

The purpose of the present invention is to provide a hydraulic control system and a hydraulic control method to solve the problems in the prior art of great limitation to engine model selection of a hydraulic control system, or the system is designed with complicated pipelines with high heat emission, multiple fault sources, and unsatisfactory micro-motion performance.

Therefore, the present invention provides a hydraulic control system according to an aspect of the present invention.

The hydraulic control system comprises: a first closed pump and a first engine connected with each other, a second closed pump and a second engine connected with each other, and a hydraulic motor, wherein the first closed pump, the second closed pump and the hydraulic motor are connected in parallel.

Further, the hydraulic control system of the present invention comprises a brake connected to the output end of the hydraulic motor.

Further, the hydraulic control system of the present invention comprises a controller connected to the first engine and the second engine. The controller is configured to start the first engine and the second engine, and is further configured to stop the first engine or the second engine correspondingly when a failure of the first closed pump or the second closed pump occurs.

Further, the controller is configured to detect the rotational speed of the first engine and that of the second engine and calculate the difference between the two. In the case that the difference is larger than a preset value, if the current operation is a hoisting operation, increase the rotational speed of the engine with a relatively low rotational speed; if the current operation is a lowering operation, reduce the displacement of the pump with a relatively high rotational speed.

Further, the controller is connected with the first closed pump, the second closed pump and the hydraulic motor and configured to detect the rotational speed of the hydraulic motor, and regulate displacement of the first closed pump and that of the second closed pump so hat the rotational speed of the hydraulic motor is a preset value.

To realize the purpose above, a hydraulic control method is provided according to another aspect of the present invention.

The hydraulic control method of the present invention is applied to the hydraulic control system of the present invention. The method comprises: stopping the first engine or the second engine correspondingly when a failure of the first closed pump or the second closed pump occurs.

To realize the purpose above, another hydraulic control method is provided according to another aspect of the present invention.

The hydraulic control method of the present invention is applied to the hydraulic control system of the present invention. The method comprises: detecting the rotational speed of the first engine and that of the second engine in the hydraulic control system and calculating the difference between the two; in the case that the difference is larger than a preset value, if the current operation is a hoisting operation, increasing the rotational speed of the engine with a relatively low rotational speed; if the current operation is a lowering operation, reducing the displacement of the pump with a relatively high rotational speed.

Further, the method comprises: detecting the rotational speed of the hydraulic motor, and adjusting the displacement of the first closed pump and that of the second closed pump so that the rotational speed of the hydraulic motor is a preset value.

To realize the purpose above, another hydraulic control method is provided according to another aspect of the present invention.

The hydraulic control method of the present invention is applied to the hydraulic control system of the present invention. The method comprises detecting the rotational speed of the hydraulic motor; adjusting the displacement of the first closed pump and that of the second closed pump so that the rotational speed of the hydraulic motor is a preset value.

By applying the technical solution of the present invention, pumps connected in parallel are applied to select engines with relatively low power so as to achieve wider engine model selection range. The present invention utilizes closed pumps to avoid use of related pipelines and components for throttle control, such as reversing valves etc. Therefore, the hydraulic pipelines are simple with low heat emission and less fault sources. In addition, the impact generated by opening and closing valves is reduced, thus increasing the micro-motion performance.

### BRIEF DESCRIPTION OF THE DRAWINGS

Drawings, which form a part of the description and are provided for further understanding of the present invention, show the preferred embodiments of the present invention, and explain the principle of the present invention together with the description. In the drawings:

FIG. 1 is a schematic diagram illustrating a structure of the hydraulic control system in an embodiment of the present invention.

### DETAILED DESCRIPTION OF THE EMBODIMENTS

Drawings, which form a part of the description and are provided for further understanding of the present invention, show the preferred embodiments of the present invention, and explain the principle of the present invention together with the description. In the drawings:

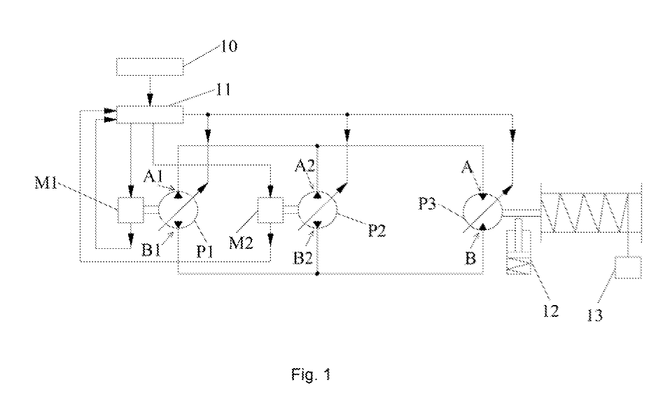

FIG. 1 is a schematic diagram illustrating a structure of a hydraulic control system in an embodiment of the present invention.

As shown in FIG. 1, the hydraulic control system in the embodiment of the present invention mainly comprises a first engine M1, and a first closed pump P1 connected thereto, a second engine M2 and a second closed pump P2 connected thereto, and a hydraulic motor P3. The hydraulic motor P3 serves as an actuator.

The first closed pump P1, the second closed pump P2 and the hydraulic motor P3 are connected in parallel. That is, a high pressure port A1 of the first dosed pump P1, a high pressure port A2 of the second closed pump P2 and port A of the hydraulic motor P3 are connected to each other; a low pressure port B1 of the first closed pump P1, a low pressure port B2 of the second closed pump P2 and port B of the hydraulic motor P3 are connected to each other.

The hydraulic control system in the present embodiment may further comprise a brake 12 to immobilize the movement of a load 13. In addition, the hydraulic control system in the present embodiment may further comprises a controller 11. The controller 11 may apply an existing control device, such as a Programmable Logic Controller (PLC).

The controller 11 is connected to the first engine M1 and the second engine M2 so as to control the rotational speed of these two engines, thus controlling the output torques of these two engines and controlling starting and stopping of these two engines.

A hydraulic control method in the present embodiment is described below. The hydraulic control method may be realized by an existing control device, such as a PLC.

In order to control the torques of the first engine M1 and the second engine M2 to avoid a flameout due to an inadequate torque or a runaway due to a too-large torque, the controller may detect the rotational speed of the first engine M1 and that of the second engine M2 and calculate the difference between the two. If the difference is beyond a preset range, then the rotational speed of the engine with a relatively low rotational speed is increased if the current operation is a hoisting operation, and the displacement of the pump with a relatively high rotational speed is reduced if the current operation is a lowering operation, so as to control the output power of the closed pumps within an allowed range. For example, if the rotational speed of the second engine M2 is relatively high, then the displacement of the second closed pump P2 is reduced. The preset range of the difference may be determined by tests. The hoisting operation and the lowering operation here refer to hoisting a load to a higher position and lowering a load to a lower position by a crane, respectively.

If the hoisting speed or lowering speed of a load needs to be regulated, the controller 11 can detect the rotational speed of the hydraulic motor P3 and regulate the displacement of the first closed pump P1 and that of the second closed pump P2. So that the rotational speed of the hydraulic motor P3 is a preset value.

In the present embodiment, an operator of the crane may observe the moving speed of the load and then realizes the preset value of the rotational speed of the hydraulic motor by operating a control handle 10. At the moment, the moving speed of the load also meets operation requirements.

If a failure of the first closed pump P1 or the second closed pump P2 occurs, the controller 11 stops the first engine M1 or the second engine M2 correspondingly. For the time being, only the second engine M2 or the first engine M2 works correspondingly. In this way, the first engine M1 and the second engine M2 are backup engines for each other, thus increasing the system reliability.

It can be seen from the description above that, by applying the technical solution of the present invention, pumps connected in parallel are applied to select engines with relatively low power so as to achieve wider engine model selection range. The embodiments of the present invention utilize closed pumps to avoid use of related pipelines and components for throttle control, such as reversing valves etc. Therefore, the hydraulic pipelines are simple with low heat emission and less fault sources. In addition, the impact generated by opening and closing valves is reduced, thus increasing the micro-motion performance.

Above contents only describe the preferred embodiments of the present invention and are not intended to limit the present invention; for one skilled in the art, the present invention may have various modifications and changes. Any modifications, equivalent replacements and improvements made within the spirit and principle of the present invention should be included within the protection scope of the present invention.

What is claimed is:

1. A hydraulic control system, comprising:
a first closed pump and a first engine connected with each other;
second closed pump and a second engine connected with each other; and
a hydraulic motor, wherein
the first closed pump, the second closed pump and the hydraulic motor are connected in parallel.

2. The hydraulic control system according to claim 1, wherein it further comprises a brake connected to the output end of the hydraulic motor.

3. The hydraulic control system according to claim 1, wherein it further comprises a controller connected to the first engine and the second engine; the controller is configured to start the first engine and the second engine, and is further configured to stop the first engine or the second engine correspondingly when a failure of the first closed pump or the second closed pump occurs.

4. The hydraulic control system according to claim 3, wherein the controller is further configured to detect the rotational speed of the first engine and that of the second engine and calculate the difference between the two;
in the case that the difference is larger than a preset value,
if the current operation is a hoisting operation, increase the rotational speed of the engine with a relatively low rotational speed;
if the current operation is a lowering operation, reduce the displacement of the pump with a relatively high rotational speed.

5. The hydraulic control system according to claim 4, wherein the controller is further connected with the first closed pump, the second closed pump and the hydraulic motor and configured to:
detect the rotational speed of the hydraulic motor;
regulate the displacement of the first closed pump and that of the second closed pump so that the rotational speed of the hydraulic motor is a preset value.

6. The hydraulic control system according to claim 1, wherein it further comprises a controller connected with the first closed pump, the second closed pump and the hydraulic motor and configured to:
detect the rotational speed of the hydraulic motor;
regulate the displacement of the first closed pump and that of the second closed pump so that the rotational speed of the hydraulic motor is a preset value.

7. A hydraulic control method applied to the hydraulic control system according to claim 1, wherein the method comprising: stopping the first engine or the second engine correspondingly when a failure of the first closed pump or the second closed pump occurs.

8. A hydraulic control method applied to the hydraulic control system according to claim 1, wherein the method comprising:
detecting the rotational speed of the first engine and that of the second engine in the hydraulic control system and calculating the difference between the two;
in the case that the difference is larger than a preset value,
if the current operation is a hoisting operation, increasing the rotational speed of the engine with a relatively low rotational speed;
if the current operation is a lowering operation, reducing the displacement of the pump with a relatively high rotational speed.

9. The method according to claim 8, wherein it further comprising:
detecting the rotational speed of the hydraulic motor;
adjusting the displacement of the first closed pump and that of the second closed pump so that the rotational speed of the hydraulic motor is a preset value.

10. A hydraulic control method applied to the hydraulic control system according to claim 1, wherein the method comprising:
detecting the rotational speed of the hydraulic motor;
adjusting the displacement of the first dosed pump and that of the second dosed pump so that the rotational speed of the hydraulic motor is a preset value.

11. The hydraulic control system according to claim 2, wherein it further comprises a controller connected to the first engine and the second engine; the controller is configured to start the first engine and the second engine, and is further configured to stop the first engine or the second engine correspondingly when a failure of the first closed pump or the second closed pump occurs.

12. The hydraulic control system according to claim 3, wherein the controller is further configured to detect the rotational speed of the first engine and that of the second engine and calculate the difference between the two;
in the case that the difference is larger than a preset value,
if the current operation is a hoisting operation, increase the rotational speed of the engine with a relatively low rotational speed;
if the current operation is a lowering operation, reduce the displacement of the pump with a relatively high rotational speed.

13. The hydraulic control system according to claim 4, wherein the controller is further connected with the first closed pump, the second closed pump and the hydraulic motor and configured to:
detect the rotational speed of the hydraulic motor;
regulate the displacement of the first closed pump and that of the second closed pump so that the rotational speed of the hydraulic motor is a preset value.

14. The hydraulic control system according to claim 2, wherein it further comprises a controller connected with the first closed pump, the second closed pump and the hydraulic motor and configured to:
detect the rotational speed of the hydraulic motor;
regulate the displacement of the first closed pump and that of the second closed pump so that the rotational speed of the hydraulic motor is a preset value.
